(19) United States
(12) Patent Application Publication
(10) Pub. No.: US 2020/0159734 A1
(43) Pub. Date: May 21, 2020

(54) DATA TRACKING APPARATUS, METHOD, AND NON-TRANSITORY COMPUTER READABLE STORAGE MEDIUM THEREOF

(71) Applicant: BigObject Inc., Taipei City (TW)

(72) Inventors: Tyng-Rong ROAN, Taipei City (TW); Wenwey HSEUSH, Taipei City (TW)

(21) Appl. No.: 16/217,903

(22) Filed: Dec. 12, 2018

(30) Foreign Application Priority Data
Nov. 21, 2018 (TW) 107141493

(51) Int. Cl. G06F 16/2455; G06F 16/2458; G06F 16/955; G06F 16/248

(52) U.S. Cl. CPC G06F 16/24568; G06F 16/248; G06F 16/9558; G06F 16/2477

(57) ABSTRACT

A data tracking apparatus, method, and non-transitory computer readable storage medium thereof are provided. The data tracking apparatus receives a stream of data continuously and stores a fact dataset, wherein the fact dataset is updated by the stream of data continuously. The fact dataset includes a plurality of fact records, wherein each of the fact records includes an identity value. The data tracking apparatus locates a tracking target by querying the fact dataset corresponding to a first time instant according to a first query command, wherein the tracking target includes a subset of the identity values. The data tracking apparatus derives a tracked dataset by querying the fact dataset corresponding to a second time instant according to the tracking target and a second query command.

### PRIORITY CLAIM

This application claims priority to Taiwan Patent Application No. 107141493 filed on Nov. 21, 2018, which is hereby incorporated by reference in its entirety.

### CROSS-REFERENCES TO RELATED APPLICATIONS

Not applicable.

### BACKGROUND OF THE INVENTION

### Field of the Invention

The present invention relates to a data tracking apparatus, method, and non-transitory computer readable storage medium thereof that are related to a stream of data. Specifically, the present invention relates to a data tracking apparatus, method, and non-transitory computer readable storage medium that locate and track a tracking target in a stream of data.

### Descriptions of the Related Art

In the recent trend of big data, a special category of data, referred to as “stream of” data (also referred to as “data stream” or “streaming data”) has been identified and focused in the area of analytics. Stream of data has the following three characteristics, including: (1) being non-stop and generated from the real world in real time order, (2) being immutable and collected as time-series data, and (3) more recent data being more valuable in business. Data generated by Internet of Things (IoT) systems, mobile applications, or large-scale Web services are usually stream of data.

Regarding big data, conventional technologies simply collect and store them in a repository for future analyses. That is, only when there is a need in digging information from the big data will the conventional technologies retrieve them from the repository and then perform the required analyses. Conventional technologies do not take the aforesaid three characteristics into consideration, hence data services provided by them are limited to existing types. Furthermore, analyses performed by conventional technologies are only based on the big data stored in the repository (i.e. without the latest generated data) and, therefore, the results of analyses become inaccurate. Accordingly, there is an urgent need for a technology that can take the aforesaid three characteristics of stream of data into consideration and provide instant and accurate analysis, various kinds of data services, and continuously track a tracking target according to the continuously changing steam of data.

### SUMMARY OF THE INVENTION

To solve the aforesaid problems of conventional technologies, the present invention provides a data tracking apparatus, method, and non-transitory computer readable storage medium thereof for dealing with stream of data.

The data tracking apparatus provided by the present invention comprises a transceiving interface, a storage, and a processor, wherein the processor is electrically connected to the transceiving interface and the storage. The transceiving interface is configured to receive a stream of data continuously. The storage stores a fact dataset, wherein the fact dataset is updated by the stream of data continuously. The fact dataset comprises a plurality of fact records, and each of the fact records comprises an identity value. The processor is configured to locate a tracking target by querying the fact dataset corresponding to a first time instant according to a first query command, wherein the tracking target comprises a subset of the identity values. The processor is further configured to derives a tracked dataset by querying the fact dataset corresponding to a second time instant according to the tracking target and a second query command.

The data tracking method of the present invention is adapted for an electronic computing apparatus. The data tracking method comprises the following steps of: (a) receiving a stream of data continuously, (b) storing a fact dataset, wherein the fact dataset is updated by the stream of data continuously, the fact dataset comprises a plurality of fact records, and each of the fact records comprises an identity value, (c) locating a tracking target by querying the fact dataset corresponding to a first time instant according to a first query command, wherein the tracking target comprises a subset of the identity values, and (d) deriving a tracked dataset by querying the fact dataset corresponding to a second time instant according to the tracking target and a second query command.

The non-transitory computer readable storage medium provided by the present invention stores a computer program comprising a plurality of codes. After the computer program is loaded into an electronic computing apparatus, the electronic computing apparatus executes the codes of the computer program to perform the data tracking method described in the above paragraph.

The data tracking technology (including the apparatus, method, and non-transitory computer readable storage medium) provided by the present invention continuously receives a steam of data and continuously updates a fact dataset according to the steam of data so that new fact data in the stream of data can be utilized immediately after the new fact data is received. Since the fact dataset is updated continuously, the fact datasets corresponding to different time instants are different.

The data tracking technology provided by the present invention can query a fact dataset corresponding to a certain time instant according to a query command and thereby locate a tracking target. After locating the tracking target, the data tracking technology provided by the present invention can query the fact dataset corresponding to another time instant according to the tracking target and another query command (which depends on the item/information that a user would like to discover from the tracking target) and thereby derive a tracked dataset corresponding to the tracking target and achieve the technical effect of tracking the tracking target. Since the data tracking technology provided by the present invention updates the fact dataset continuously and tracks the tracking target according to the latest fact dataset, the present invention is capable of providing an instant and accurate tracking result.

The data tracking technology provided by the present invention may repeat the aforesaid operations to locate and then track multiple tracking targets, may perform various kinds of tracking based on multiple tracking targets (e.g., an union or an intersection of the tracking targets), and may provide a direct link and/or a share link to a user for tracking at various time instants afterwards. According to the aforesaid operations, the data tracking technology provided by the present invention achieves the technical effect of providing a diverse range of data services.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A illustrates a schematic view of the data tracking apparatus 1 of the first embodiment;

FIG. 1B illustrates a schematic view of the fact dataset 12 corresponding to each of the time instants t1, t2, and t3; and

FIG. 2 is a flowchart of the data tracking method according to a second embodiment.

### DESCRIPTION OF THE PREFERRED EMBODIMENT

In the following description, a data tracking apparatus, method, and non-transitory computer readable storage medium thereof provided by the present invention will be explained with reference to embodiments thereof. However, these embodiments are not intended to limit the present invention to any environment, applications, or implementations described in these embodiments. Therefore, description of these embodiments is only for purpose of illustration rather than to limit the present invention. It shall be appreciated that elements unrelated to the present invention are omitted from depiction in the following embodiments and the attached drawings. In addition, dimensions of elements and dimensional relationships among individual elements in the attached drawings are only for the purpose of illustration, but not to limit the scope of the present invention.

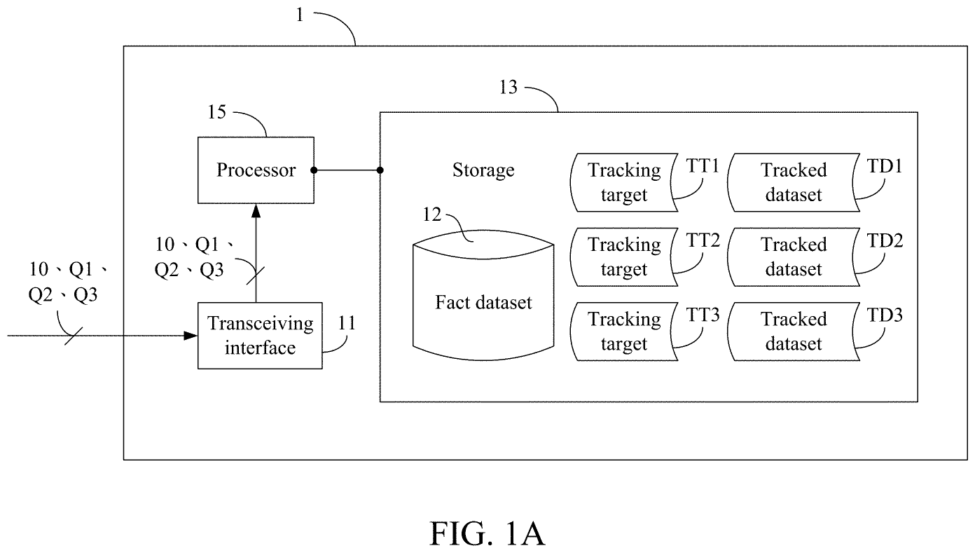

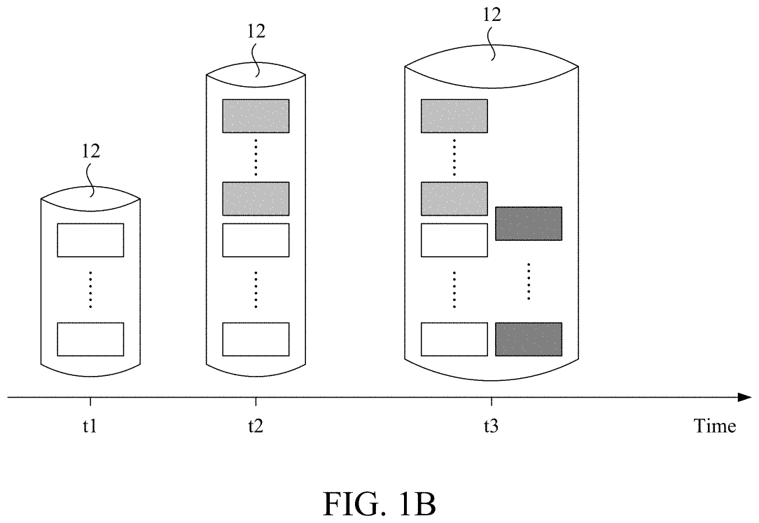

The first embodiment of the present invention is a data tracking apparatus 1, whose schematic view is illustrated in FIG. 1A. The data tracking apparatus 1 comprises a transceiving interface 11, a storage 13, and a processor 15, where in the processor 15 is electrically connected to the transceiving interface 11 and the storage 13. The transceiving interface 11 maybe a wired interface or a wireless interface, which is configured to connect to a network (e.g., an Internet, a local area network, but not limited thereto) for transceiving signals and receiving data via the network. The storage 13 may be a hard disk (e.g., solid state disk) or other non-transitory computer readable storage medium/device that can be installed various kinds of data repository and well-known to those skilled in the art. The processor 15 may be any kind of processing unit, central processing unit (CPU), microprocessor, digital signal processor (DSP), or any kind of computing device with similar functions and well-known to those skilled in the art.

The data tracking apparatus 1 may cooperate with a system which generates a stream of data, e.g., an Internet of Things (IoT) system, a mobile application, a large-scale Web service, but not limited thereto. The data tracking apparatus 1 provides data services based on the continuously changing stream of data. Specifically, the data tracking apparatus 1 is capable of locating a tracking target in the continuously changing stream of data and tracking the tracking target in various way. The details are described in the following paragraphs.

The storage 13 of the data tracking apparatus 1 stores a fact dataset 12. The fact dataset 12 comprises a plurality of fact records, wherein each of the fact records comprises an identity value (not shown) and the fact data of at least one item (not shown). The present invention does not set a restriction on the way that the storage 13 stores the fact dataset 12. For example, the fact dataset 12 may be stored in a database management system which is installed in the storage 13.

The transceiving interface 11 continuously receives a stream of data 10, and the processor 15 continuously updates the fact dataset 12 according to the stream of data 10 (i.e. the processor 15 adds the new fact record(s) into the fact dataset 12 to comprise the new fact data). In this embodiment, as time lapses, the number of the fact records comprised in the fact dataset 12 gradually increases as shown in FIG. 1B. In FIG. 1B, every rectangle in the fact dataset 12 represents a fact record, the light grey rectangles represent the additional fact records received from the time instant t1 to the time instant t2, and the dark grey rectangles represent the additional fact records received from the time instant t2 to the time instant t3. In some embodiments, in addition to updating the fact dataset 12 by the new fact data in the stream of data 10, the processor 15 also deletes the obsolete fact record(s) in the fact dataset 12 (e.g. deleting the fact record that has been stored in the fact dataset 12 for more than a default time length).

The fact dataset 12 stored in the storage 13 may queried by a user. The present invention does not limit the way of querying the fact dataset 12 to any specific way. For example, if the fact dataset 12 is stored in a database management system installed in the storage 13, a user may query the fact dataset 12 by using the query language (e.g., the Structured Query Language (SQL)) provided by the database management system. In this embodiment, the user transmits query command(s) via transceiving interface 11 to the data tracking apparatus 1. In other embodiments, the user may input query command(s) via other input interface (not shown) to the data tracking apparatus 1.

It is assumed that the transceiving interface 11 of the data tracking apparatus 1 receives a query command Q1 (e.g. querying the users who had bought a specific product) at a certain time instant. After the data tracking apparatus 1 obtains the query command Q1, the processor 15 queries the fact dataset 12 corresponding to a time instant t1 according to the query command Q1 and thereby locate a tracking target TT1 (e.g., locating the identity value of the users who had bought a specific product). The tracking target TT1 is a subset (not shown) of the identity values comprised in the fact dataset 12 corresponding to the time instant t1. In some embodiments, the processor 15 may retrieve a subset (not shown) of the fact records from the fact dataset 12 corresponding to the time instant t1 according to the query command Q1 (i.e. finding out the fact records that satisfy the criterion/criteria recorded in the query command Q1) and then form the tracking target TT1 by recording the identity values of each fact record comprised in the subset.

Please note that the time instant that the data tracking apparatus 1 obtains the query command Q1 is relatively close to the time instant t1 that the processor 15 queries the fact dataset 12 according to the query command Q1 (e.g., the time difference therebetween is shorter than a predetermined time length). Thus, the tracking target TT1, the query result derived by the processor 15, can reflect the actual situation of the time instant that the user input the query command Q1. The processor 15 may store the tracking target TT1 in the storage 13, display the tracking target TT1 on a display device (not shown), and/or transmit the tracking target TT1 to the user via the transceiving interface 11 or other output interface (not shown).

Afterwards, the data tracking apparatus 1 may track the tracking target TT1. It is assumed that the transceiving interface 11 of the data tracking apparatus 1 receives a query command Q2 regarding the tracking target TT1 at a certain time instant. After the data tracking apparatus 1 obtains the query command Q2, the processor 15 queries the fact dataset 12 corresponding to a time instant t2 according to the tracking target TT1 and the query command Q2 and thereby derive a tracked dataset TD1. The content of the query command Q2 depends on the item/information that the user would like to discover from the tracking target TT1 (e.g., among the users who had bought a specific product, finding out who had been to a specific country). The tracked dataset TD1 derived by the data tracking apparatus 1 is the tracking result of the tracking target TT1 at the time instant t2.

Please note that the time instant that the data tracking apparatus 1 obtains the query command Q2 is relatively close to the time instant t2 that the processor 15 queries the fact dataset 12 according to the tracking target TT1 and the query command Q2 (e.g., the time difference therebetween is shorter than a predetermined time length). Therefore, the tracking target TD1 obtained by the processor 15 can reflect the actual situation of the time instant that the user input the query command Q2. The processor 15 may store the tracked dataset TD1 in the storage 13, display the tracked dataset TD1 on a display device (not shown), and/or transmit the tracked dataset TD1 to the user via the transceiving interface 11 or other output interface (not shown). In some embodiments, the processor 15 may further generate a report (not shown) comprising the tracked dataset TD1 and transmit the report to the user via the transceiving interface 11 or other output interface.

In some embodiment, the processor 15 further locates a tracking target TT2 by recording the identity value of each fact record in the tracked dataset TD1 (e.g. the users who had bought a specific product and had been to a specific country). In other words, the processor 15 may locate another tracking target TT2 according to the tracked dataset TD1. Similarly, the processor 15 may store the tracking target TT2 in the storage 13, display the tracking target TT2 on the display device (not shown), and/or transmit the tracking target TT2 to the user via the transceiving interface 11 or other output interface (not shown). Afterwards, the data tracking apparatus 1 may track the tracking target TT2. In other words, the processor 15 may query the fact dataset 12 corresponding to another time instant (not shown) according to the tracking target TT2 and another query command (not shown) and thereby derive another tracked dataset (not shown). The details are not repeated herein.

In some embodiments, the data tracking apparatus 1 further generates a direct link regarding the aforesaid tracking so that the user can perform the follow-up tracking in the future. Specifically, after the processor 15 queries the fact dataset 12 corresponding to the time instant t2 according to the tracking target TT1 and the query command Q2, the processor 15 generates a direct link (not shown) comprising at least one parameter corresponding to the query command Q2 (e.g., the item listed in the query command Q2 that reflects what the user would like to query). The content of the direct link and the way to generate the direct link shall be readily appreciated by people skilled in the art, so the details will not be described herein. The data tracking apparatus 1 transmits the direct link to the user via the transceiving interface 11 or other output interface (not shown). In these embodiments, if the user triggers the direct link, the processor 15 will query the fact dataset 12 corresponding to a time instant t3 according to the tracking target TT1 and the query command Q2 in response to the trigger of the direct link and thereby derive a tracked dataset TD2.

Please note that the time instant that the direct link is triggered is relatively close to the time instant t3 (e.g., the time difference therebetween is shorter than a predetermined time length). Thus, the tracked dataset TD2 obtained by the processor 15 by querying the fact dataset 12 according to the tracking target TT1 and the query command Q2 can reflect the actual situation of the time instant at which the direct link is triggered. By providing the direct link to the user, the data tracking apparatus 1 lets the user keep on tracking the tracking target TT1 by the query command Q2 at subsequent different time instants.

In some embodiments, the data tracking apparatus 1 further generates a share link regarding the aforesaid tracking so that the user can perform the follow-up tracking in the future. Specifically, after the processor 15 queries the fact dataset 12 corresponding to the time instant t2 according to the tracking target TT1 and the query command Q2, the processor 15 generates a share link according to a user information, a security setting, an access control, and at least one parameter corresponding to the query command Q2. The content of the share link and the way to generate the share link shall be readily appreciated by people skilled in the art, so the details will not be described herein. The data tracking apparatus 1 transmits the share link to the user via the transceiving interface 11 or other output interface (not shown). In these embodiments, if the user triggers the share link, the processor 15 will query the fact dataset 12 corresponding to a time instant t3 according to the tracking target TT1 and the query command Q2 in response to the trigger of the share link and thereby derive a tracked dataset TD2. By providing the share link to the user, the data tracking apparatus 1 allows the user to keep on tracking the tracking target TT1 at subsequent different time instants by the query command Q2.

In some embodiments, the processor 15 may store the tracked dataset TD2 in the storage 13, display the tracked dataset TD2on the display device (not shown), and/or transmit the tracked dataset TD2 to the user via the transceiving interface 11 or other output interface (not shown). In some embodiments, the processor 15 may further generate a report comprising the tracked dataset TD2 and the report may be transmitted to the user via the transceiving interface 11 or other output interface. By comparing the tracked dataset TD1 with the tracked dataset TD2, the processor 15 can find out the change of the tracking target TT1 from the time instant t2 to the time instant t3.

In some embodiments, the processor 15 may perform various types of tracking based on multiple tracking targets. Specifically, the processor 15 may query the fact dataset 12 corresponding to a certain time instant according to a query command Q3, the tracking target TT1, and the tracking target TT2 and thereby derive a tracked dataset TD3 and locate a tracking target TT3. For example, the processor 15 may obtain an intersection (or a union) of the tracking target TT1 and the tracking target TT2 and then query the fact dataset 12 corresponding to a certain time instant according to the query command Q3 and the intersection (or the union) of the tracking target TT1 and the tracking target TT2 and thereby derive the track dataset TD3. The processor 15 further locates the tracking target TT3 by recording the identity value of each fact record in the tracked dataset TD3. Similarly, the tracking target TT3 and the tracked dataset TD3 may be stored in the storage 13, displayed on the display device (not shown), and/or transmitted to the user via the transceiving interface 11 or other output interface (not shown). Afterwards, the data tracking apparatus 1 may track the tracking target TT3.

According to the above descriptions, the data tracking apparatus 1 can query the fact dataset 12 corresponding to a certain time instant according to a query command and thereby locate a tracking target. After locating the tracking target, the data tracking apparatus 1 can query the fact dataset corresponding to another time instant according to the tracking target and another query command (which depends on the item/information that a user would like to discover from the tracking target) and thereby derive a tracked dataset corresponding to the tracking target and achieve the technical effect of tracking the tracking target. The data tracking apparatus 1 can locate multiple tracking targets and perform various types of tracking based on the multiple tracking targets (e.g., the union or the intersection of the tracking targets). The data tracking apparatus 1 can provide a direct link and/or a share link to a user for tracking at various time instants afterwards. By the aforesaid operations, the data tracking apparatus 1 achieves the technical effect of providing a diverse range of data services. In addition, since the data tracking apparatus 1 continuously receives the steam of data 10 and continuously updates the fact dataset 12, the data tracking apparatus 1 can provide an instant and accurate tracking result.

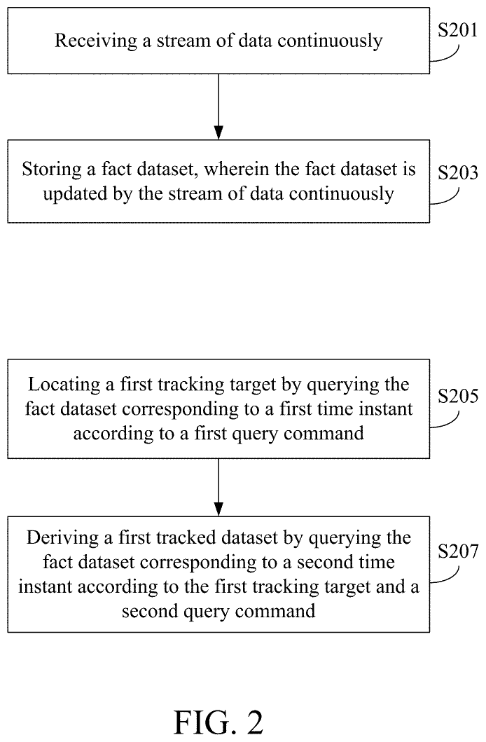

The second embodiment of the present invention is a data tracking method and a flowchart of which is illustrated in FIG. 2. The data tracking method is adapted for use in an electronic computing apparatus, e.g., the data tracking apparatus 1 in the first embodiment. The data tracking method comprises at least the step S201 to the step S207, wherein the step S201 and the step S203 relate to receiving a stream of data and updating a fact dataset and the step S205 and the step S207 relate to locating and tracking a tracking target. In this embodiment, the step S201 and the step S203 are executed continuously; that is, the step S201 and the step S203 will be executed when there is new fact data in the steam of data.

Specifically, in the step S201, the electronic computing apparatus receives a steam of data continuously. In the step S203, the electronic computing apparatus stores a fact dataset, wherein the fact dataset comprises a plurality of fact records and each of the fact records comprises an identity value and the fact data of at least one item. Furthermore, the step S203 continuously updates the fact dataset by the stream of data (i.e., new fact record(s) will be added into the fact dataset so that the new fact data are included).

Moreover, in step S205, the electronic computing apparatus queries the fact dataset corresponding to a first time instant (e.g., the fact dataset 12 corresponding to the time instant t1 in FIG. 1B) and thereby locates a first tracking target, wherein the first tracking target comprises a first subset of the identity values. In some embodiments, the step S205 may comprise a step (not shown) for retrieving a second subset of the fact records in the fact dataset corresponding to the first time instant according to the first query command and another step (not shown) for forming the first subset by recording the identity value of each fact record in the second subset.

Afterwards, the data tracking method may track the first tracking target. Specifically, in the step S207, the electronic computing apparatus queries the fact dataset corresponding to a second time instant (e.g., the fact dataset 12 corresponding to the time instant t2 shown in FIG. 1B) according to the first tracking target and a second query command and thereby derives the first tracked dataset. The first tracked dataset derived by the data tracking method is the tracking result of the first tracking target at the second time instant.

In some embodiments, the data tracking method may further comprise a step (not shown) for locating, by the electronic computing apparatus, a second tracking target by recording the identity value of each fact record in the first tracked dataset. Afterwards, the data tracking method may track the second tracking target by similar way. The details are not repeated herein.

In some embodiments, the data tracking method may further generate a direct link regarding the aforesaid tracking so that the user can continuously tracking in the future. Specifically, the data tracking method may further comprise a step (not shown) for generating a direct link by the electronic computing apparatus, wherein the direct link comprises at least one parameter corresponding to the second query command. In these embodiments, the data tracking method may further comprise a step (not shown) for querying, by the electronic computing apparatus, the fact dataset corresponding to a third time instant according to the first tracking target and the second query command in response to a trigger of the direct link and thereby derive a second tracking dataset. In these embodiments, the data tracking method may further comprise a step (not shown) for generating a first report by the electronic computing apparatus and another step (not shown) for generating a second report by the electronic computing apparatus, wherein the first report comprises the first tracked dataset and the second report comprises the second tracked dataset.

In some embodiments, the data tracking method may further generate a share link regarding the aforesaid tracking so that the user can continuously tracking in the future. Specifically, the data tracking method may further comprise a step (not shown) for generating, by the electronic computing apparatus, a share link according to a user information, a security setting, an access control, and at least one parameter corresponding to the second query command. In these embodiments, the data tracking method may further comprise a step (not shown) for querying, by the electronic computing apparatus, the fact dataset corresponding to a third time instant according to the first tracking target and the second query command in response to a trigger of the share link and thereby derive a second tracked dataset. Similarly, in these embodiments, the data tracking method may further comprise a step (not shown) for generating a first report by the electronic computing apparatus and another step for generating a second report by the electronic computing apparatus, wherein the first report comprises the first tracked dataset and the second report comprises the second tracked dataset.

In some embodiments, the data tracking method may locate multiple tracking targets and perform various types of tracking based on the multiple tracking targets. Specifically, the data tracking method may further comprise a step (not shown) for querying, by the electronic computing apparatus, the fact dataset corresponding to a third time instant according to a third query command, the first tracking target, and the second tracking target (e.g., according to the third query command and an union/intersection of the first tracking target and the second tracking target) to locate a third tracking target.

In addition to the aforesaid steps, the second embodiment can execute all the operations and steps of the data tracking apparatus 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment, and thus will not be further described herein.

The data tracking method described in the second embodiment may be implemented as a computer program comprising a plurality of codes. The computer program is stored in a non-transitory computer readable storage medium. When the codes of the computer program are loaded into an electronic computing apparatus (e.g., the data tracking apparatus 1), the computer program executes the data tracking method as described in the second embodiment. The non-transitory computer-readable storage medium may be an electronic product, such as a read only memory (ROM), a flash memory, a floppy disk, a hard disk, a compact disk (CD), a digital versatile disc (DVD), a mobile disk, a database accessible to networks, or any other storage media with the same function and well known to those skilled in the art.

In the specification and the claims of the present invention, some terms (including query command, time instant, tracking target, subset, tracked dataset, report, etc.) are preceded by the terms “first,” “second,” or “third.” Please note that the terms “first,” “second,” and “third” are used only for distinguishing different terms.

In summary, the data tracking technology provided by the present invention (including the apparatus, method, and non-transitory computer readable storage medium) provides data service (i.e. locating one or multiple tracking targets and then performing various types of tracking on one or multiple tracking targets) based on the continuously changing stream of data. The data tracking technology provided by the present invention continuously receives a stream of data and continuously updates a fact dataset according to the stream of data so that the new fact data in the stream of data can be utilized immediately after the new fact data is received.

The data tracking technology provided by the present invention can query the fact dataset corresponding to a certain time instant according to a query command and thereby locate a tracking target. After locating the tracking target, the data tracking technology provided by the present invention can track the fact dataset corresponding to another time instant according to the tracking target and another query command and thereby derive a tracked dataset relating to the tracking target and achieve the technical effect of tracking the tracking target. The data tracking technology provided by the present invention continuously updates the fact dataset and tracks the tracking target based on the latest fact dataset and, therefore, the present invention can provide instant and accurate tracking result.

The data tracking technology provided by the present invention may locate and track multiple tracking targets, may perform various types of tracking based on multiple tracking targets, and may provide a direct link and/or share link to a user for tracking at different time instants afterwards. By aforesaid operations, the data tracking technology provided by the present invention achieve the technical effect of providing a diverse range of data services.

The above disclosure is only utilized to enumerate some embodiments of the present invention and illustrate the technical features thereof, but is not to limit the scope of the present invention. People of ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A data tracking apparatus, comprising:
a transceiving interface, being configured to receive a stream of data continuously;
a storage, storing a fact dataset, wherein the fact dataset is updated by the stream of data continuously, the fact dataset comprises a plurality of fact records, and each of the fact records comprises an identity value; and
a processor, being electrically connected to the transceiving interface and the storage and configured to locate a first tracking target by querying the fact dataset corresponding to a first time instant according to a first query command, wherein the first tracking target comprises a first subset of the identity values;
wherein the processor derives a first tracked dataset by querying the fact dataset corresponding to a second time instant according to the first tracking target and a second query command.

2. The data tracking apparatus of claim 1, wherein the processor locates the first tracking target by retrieving a second subset of the fact records in the fact dataset corresponding to the first time instant according to the first query command and forming the first subset by recording the identity value of each fact record in the second subset.

3. The data tracking apparatus of claim 1, wherein the processor further locates a second tracking target by recording the identity value of each fact record in the first tracked dataset.

4. The data tracking apparatus of claim 1, wherein the processor further generates a direct link comprising at least one parameter corresponding to the second query command.

5. The data tracking apparatus of claim 4, wherein the processor further derives a second tracked dataset by querying the fact dataset corresponding to a third time instant according to the first tracking target and the second query command in response to a trigger of the direct link.

6. The data tracking apparatus of claim 5, wherein the processor further generates a first report including the first tracked dataset and a second report including the second tracked dataset.

7. The data tracking apparatus of claim 1, wherein the processor further generates a share link according to a user information, a security setting, an access control, and at least one parameter corresponding to the second query command.

8. The data tracking apparatus of claim 7, wherein the processor further derives a second tracked dataset by querying the fact dataset corresponding to a third time instant according to the first tracking target and the second query command in response to a trigger of the share link.

9. The data tracking apparatus of claim 3, wherein the processor further locates a third tracking target by querying the fact dataset corresponding to a third time instant according to a third query command, the first tracking target, and the second tracking target.

10. A data tracking method for use in an electronic computing apparatus, comprising the following steps of:
receiving a stream of data continuously;
storing a fact dataset, wherein the fact dataset is updated by the stream of data continuously, the fact dataset comprises a plurality of fact records, and each of the fact records comprises an identity value;
locating a first tracking target by querying the fact dataset corresponding to a first time instant according to a first query command, wherein the first tracking target comprises a first subset of the identity values; and
deriving a first tracked dataset by querying the fact dataset corresponding to a second time instant according to the first tracking target and a second query command.

11. The data tracking method of claim 10, wherein the step of locating the first tracking target comprises the following steps of:
retrieving a second subset of the fact records in the fact dataset corresponding to the first time instant according to the first query command; and
forming the first subset by recording the identity value of each fact record in the second subset.

12. The data tracking method of claim 10, further comprising the following step of:
locating a second tracking target by recording the identity value of each fact record in the first tracked dataset.

13. The data tracking method of claim 10, further comprising the following step of:
generating a direct link comprising at least one parameter corresponding to the second query command.

14. The data tracking method of claim 13, further comprising the following step of:
deriving a second tracked dataset by querying the fact dataset corresponding to a third time instant according to the first tracking target and the second query command in response to a trigger of the direct link.

15. The data tracking method of claim 14, further comprising the following steps of:
generating a first report including the first tracked dataset; and
generating a second report including the second tracked dataset.

16. The data tracking method of claim 10, further comprising the following step of:
generating a share link according to a user information, a security setting, an access control, and at least one parameter corresponding to the second query command.

17. The data tracking method of claim 16, further comprising the following step of:
deriving a second tracked dataset by querying the fact dataset corresponding to a third time instant according to the first tracking target and the second query command in response to a trigger of the share link.

18. The data tracking method of claim 12, further comprising the following step of:
locating a third tracking target by querying the fact dataset corresponding to a third time instant according to a third query command, the first tracking target, and the second tracking target.

19. A non-transitory computer readable storage medium, storing a computer program comprising a plurality of codes, the computer program executing a data tracking method after the codes is loaded into an electronic apparatus, the data tracking method comprising the following steps of:
receiving a stream of data continuously;
storing a fact dataset, wherein the fact dataset is updated by the stream of data continuously, the fact dataset comprises a plurality of fact records, and each of the fact records comprises an identity value;
locating a first tracking target by querying the fact dataset corresponding to a first time instant according to a first query command, wherein the first tracking target comprises a first subset of the identity values; and
deriving a first tracked dataset by querying the fact dataset corresponding to a second time instant according to the first tracking target and a second query command.
